(19) United States
(12) Patent Application Publication
(10) Pub. No.: US 2018/0214335 A1
(43) Pub. Date: Aug. 2, 2018

(54) Upright spine decompression method by gravity DeCOMPRESSit

(71) Applicant: Ahmed M Soliman, Grand Prairie, TX (US)

(72) Inventor: Ahmed M Soliman, Grand Prairie, TX (US)

(21) Appl. No.: 15/418,716

(22) Filed: Jan. 28, 2017

(51) Int. Cl. A61H 1/02

(52) U.S. Cl. CPC A61H 1/0292; A61H 1/0229; A61H 2205/081; A61H 2201/1623; A61H 2201/1604; A61H 2203/0487; A61H 2201/1628; A61H 2201/1633; A61H 2201/165; A61H 2203/0425; A61H 2201/1614

(57) ABSTRACT

The method DeCOMPRESSit is to decompress the spine from natural upright position using the force of gravity as a nonlinear increasing decompression force, which is applied to a spinal column in upright position. This allows the decompression force to be focused on selective vertebrae.

The method to achieve the decompression results has attachment points to fix the body from the two natural upright positions, sitting and standing. This position will drive all not fixed parts under the attachment point down by gravity in a very natural way. There is no restriction in time by applying this method.

A seat to achieve this decompression method has a back with attachment points, a seating base with its steady part and attached to it a movable adjustable flap, several movable adjustable resting flaps and handles, several movable adjustable joints, several movable adjustable extensions and a seat-leg-support-system. Everything should be adjusted together to fit the individuality of all body shapes to achieve the maximum support to the body and to place the user in a very relaxed position.

A device to achieve this decompression method from the natural upright standing position has a harness to fix the body from under the armpits connected to a support system which contains a freely turning anchor and an adjustable belt. The support system must be placed over the head, aligned with the center of gravity of the human body. Everything should be adjusted together to fit the individuality of all body shapes to achieve the maximum support to the body and to place the user in a very relaxed position.

Other features and advantages will be apparent from the following description in conjunction with the drawings.

### BACKGROUND OF THE INVENTION

Spinal decompression is placed as one of the front leading desirable methods to treat bulging disc, herniated disc, degenerative disc diseases, posterior facet syndrome and help to relieve back pain, neck pain, joint pain, sciatica pain and to relieve pain from other areas resulting from a disorder with the nervous and musculoskeletal systems.

The non-surgical spinal decompression traditional treatments are mostly done in uncomfortable way or awkward position such as inversion tables and traction by weird looking accessories or machines with external forces.

It is medically proven when external mechanical forces are applied the resultant muscle guarding prevents the discs from being decompressed and paraspinal muscles are conditioned to oppose abrupt and linear changes in tension, but will relax if the force is applied in a smooth gradual manner.

After extensive research, we found methods of treatments caters only to certain spectrum but it was not found a single treatment, which could actually cater to all body types, overweight, obese and elderly people as well as people with special conditions, patients with heart-problem or high blood pressure patients and pregnant women to serve or to cater to the back-pain issues they have. It was not found a single treatment, done from the upright natural position without machines, weights, human assistance, or without creating unnecessary issues or done frequently, from home or office, with as low cost as possible. But in the other hand we found the high costs of the spinal alignment treatment is the reason for the back-pain patients to seek as less treatment sessions as possible or other cheaper ineffective treatments or lay it off all together to save the cost and endures the pain.

We found the insecurity and unsafety of most of the back-pain treatments are the main reason for the health insurance not to cover some of this treatment's, because it is not being approved one hundred percent by the medical academia to work. Although most of the back-pain patients are desiring the decompression therapy because it improved the pain level and they could improve their life style once again.

Its proven facts and the statistics shows that many back pain patients should not have the surgery to begin with and the success rate failed very high percentage of the ones who did back surgery's.

The need of a non-surgical method and a treatment safe to everybody from a natural upright human body position was the main reason of finding the Upright Spine Decompression Method by Gravity DeCOMPRESSit

The natural upright position is the most desired positon to any back-pain patient to reach the maximum pain relief as we found in the research and that will improve the decompression therapy treatments' all together in a manual and mechanical way to allow the disc to heal itself from sitting or standing position.

Using the gravity as the main force in the DeCOMPRESSit to decompress the spine and allow the body to manipulate itself and relax the spine by changes in tension using the medically proven method in applying the force in a smooth gradual manner not in a linear fashion so the Paraspinal muscles not to oppose changes in tension. Since the gravity does not work in a linear fashion, that makes the Upright Spine Decompression Method by Gravity DeCOMPRESSit the safest decompression method exists.

The need for myself as a previously professional athlete, got injured in the field over twenty years ago, and continue to be a professional coach and fitness trainer, to find a treatment to avoid the back surgery, was my main drive to invent this decompression method after going through all the alternative methods available, with its limitations and restrictions. I managed to have a healthy and fit lifestyle because of DeCOMPRESSit.

The Upright Spine Decompression Method by Gravity DeCOMPRESSit long-term results help to manipulate, align and decompress the spine and will not only be good for controlling back-pain and stiffness but in addition leads to more mobility, increase of communication of body systems, increase the immune function system, increase energy, enhance the range of motion, increase the essential nurturance and other substances into the disc, increase level of hormones who are responsible of absorbing nurturance necessary for weight loss as well as releasing hazardous toxins. The treatment also helps to tone and strengthen the muscles around the spine to hold it in its place. The nerve function will be improved. All that will lead to significant boosts in metabolism.

Short-term result is relief of tremendous amount of pain without creating any other issues or damaging more body systems, which is not provided by any other known treatment.

### BRIEF SUMMARY OF THE INVENTION

The method DeCOMPRESSit is to decompress the spine from natural upright position using the force of gravity as a nonlinear increasing decompression force, which is applied to a spinal column in upright position. This allows the decompression force to be focused on selective vertebrae.

The method to achieve the decompression results has attachment points to fix the body from the two natural upright positions, sitting and standing. This position will drive all not fixed parts under the attachment point down by gravity in a very natural way. There is no restriction in time by applying this method.

A seat to achieve this decompression method has a back with attachment points, a seating base with its steady part and attached to it a movable adjustable flap, several movable adjustable resting flaps and handles, several movable adjustable joints, several movable adjustable extensions and a seat-leg-support-system. Everything should be adjusted together to fit the individuality of all body shapes to achieve the maximum support to the body and to place the user in a very relaxed position.

A device to achieve this decompression method from the natural upright standing position has a harness to fix the body from under the armpits connected to a support system which contains a freely turning anchor and an adjustable belt. The support system must be placed over the head, aligned with the center of gravity of the human body. Everything should be adjusted together to fit the individuality of all body shapes to achieve the maximum support to the body and to place the user in a very relaxed position.

Other features and advantages will be apparent from the following description in conjunction with the drawings.

### BRIEF DESCRIPTION OF THE DRAWINGS

In the figures which illustrate example embodiments of the invention,

FIG. 1 shows the decompression seat in front view, 418a&b, seat base 3 and the seat-leg-support 8 in accordance with the present invention.

FIG. 2 shows the decompression seat in cavalier's perspective in accordance with the present invention.

FIG. 3 shows the decompression seat in side view with closed elements and shows 900b,901,902,414,3a,3b,3c,514,516,511,512,213b,7 in accordance with the present invention.

FIG. 4 shows the decompression seat in side view with open elements and the function of 514,515,516,6,7,3c,212b.211b,213b,2b,21b in accordance with the present invention.

FIG. 5 shows the decompression seat in side view with open elements showing the function of joint 5001 in accordance with the present invention.

FIG. 6 shows the decompression seat in side view with open elements showing the function of joint 513 adjusting the seat base 3 with its parts 3a,3b,3c out of the horizontal in accordance with the present invention.

FIG. 7 shows the decompression seat in side view with open elements showing the function of joint 513 moving the back of seat 1 up and down in accordance with the present invention.

FIG. 8 shows the decompression seat in side view with open elements showing the function of joint 512 opening the angle of the back of the seat 1 in accordance with the present invention.

FIG. 9 shows the decompression seat in side view with open elements showing the function of joint 511 adjusting the back of the seat 1 out of the vertical in accordance with the present invention.

FIG. 10 shows a vertical cut in the back of the seat 1 showing the function of the buried cervical supporting flaps 211b opens outward in the back of the seat 1 and the opening 106b in accordance with the present invention.

FIG. 11 shows a vertical cut in the back of the seat 1 showing the function of the buried armpit supporting flaps 212b opens downward in the back of the seat 1 and the opening 105b in accordance with the present invention.

FIG. 12 shows the decompression seat in side view with open elements and the function of the extensions 411,412,413,414,415,416b, 417, forearm support 2b and pair of hinge 21b in accordance with the present invention.

FIG. 13 shows the standing decompression device Velcro belt 2001, the main hanging bar 1001 and cable clipper 3001 in accordance with the present invention.

FIG. 14 shows the front view of the standing decompression device 1001,2001,3001 and harness belt 2002 in accordance with the present invention.

FIG. 15 shows the front view of the standing decompression device with magnified image of a vertical cut of the half-moon-ring 2001a and anchor 2001b in accordance with the present invention.

FIG. 16 shows the side view of the standing decompression device with harness belt 2002,2002a and the magnified image of the front view of the anchor 2001b in accordance with the present invention.

FIG. 17 shows the front view of the standing decompression device and the users' U front view in accordance with the present invention.

FIG. 18 shows the front view of the standing decompression device in use and U standing on the scale 4001 in accordance with the present invention.

FIG. 19 shows the back view of the standing decompression device in use and U standing on the scale 4001 in accordance with the present invention.

FIG. 20 shows the side view of the standing decompression device in function with the user U in the final decompression position in accordance with the present invention.

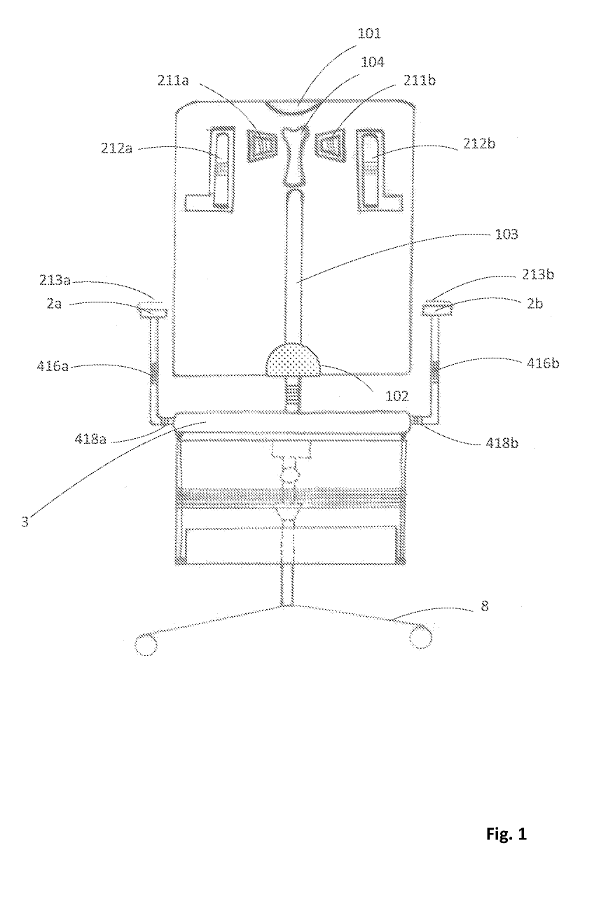

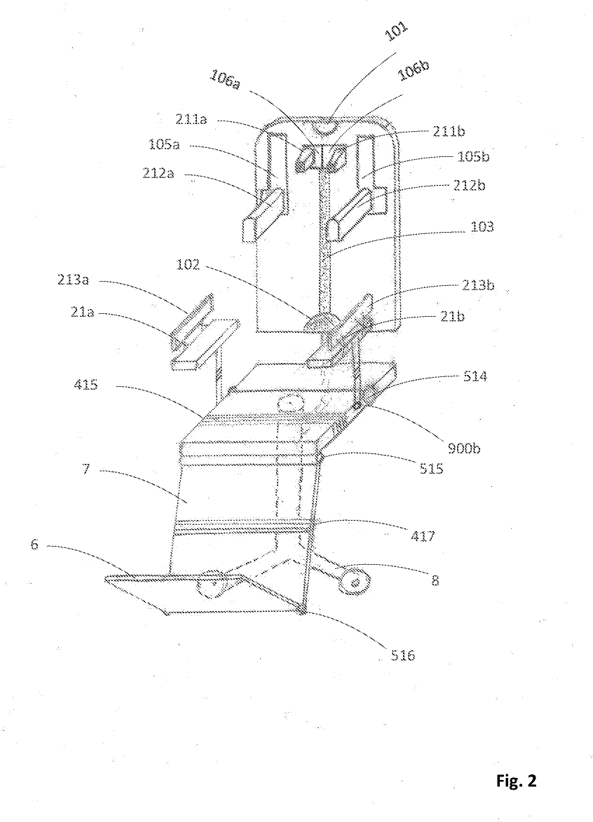

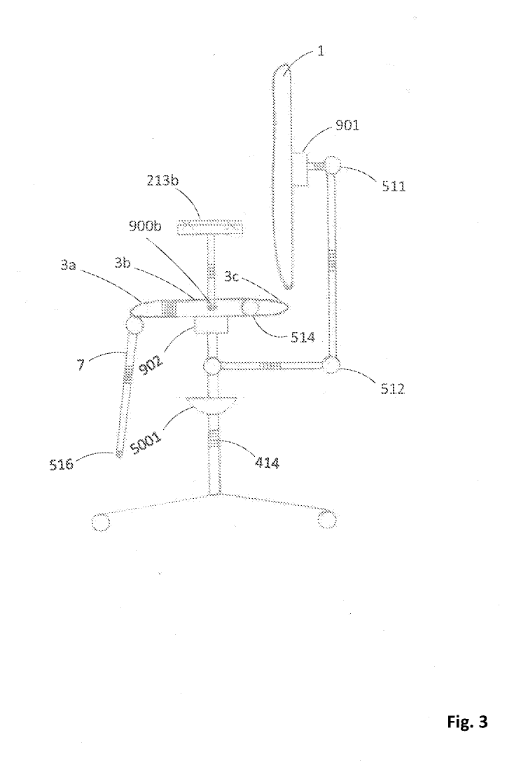

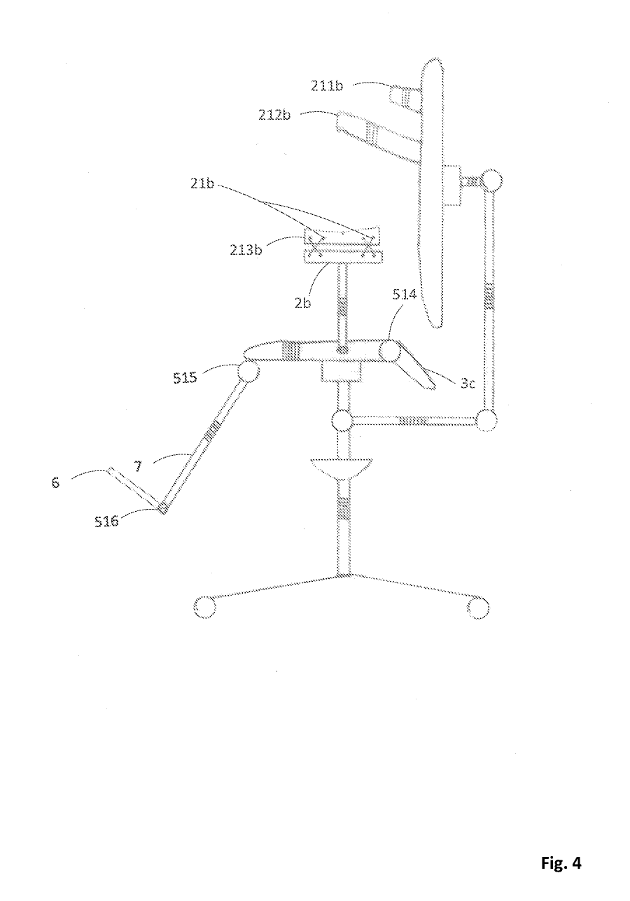

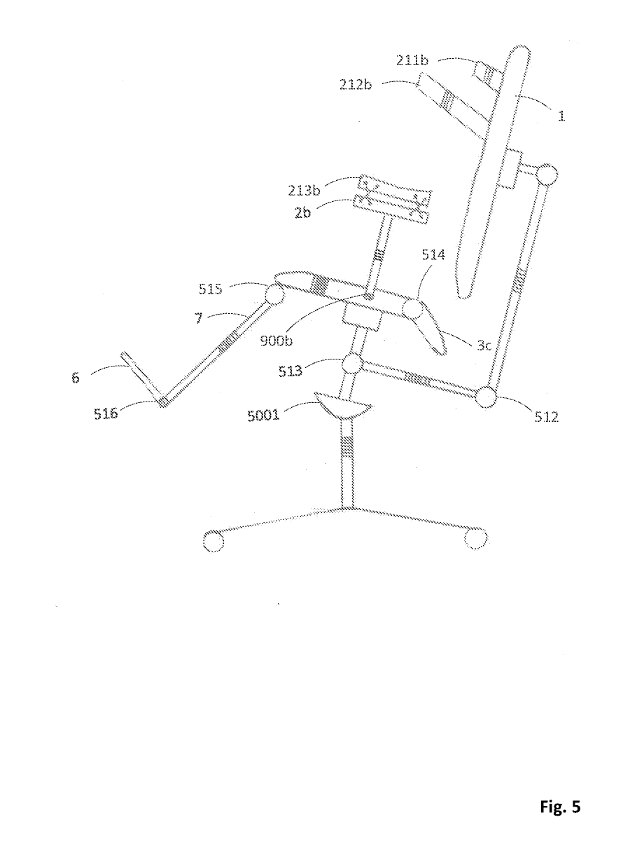

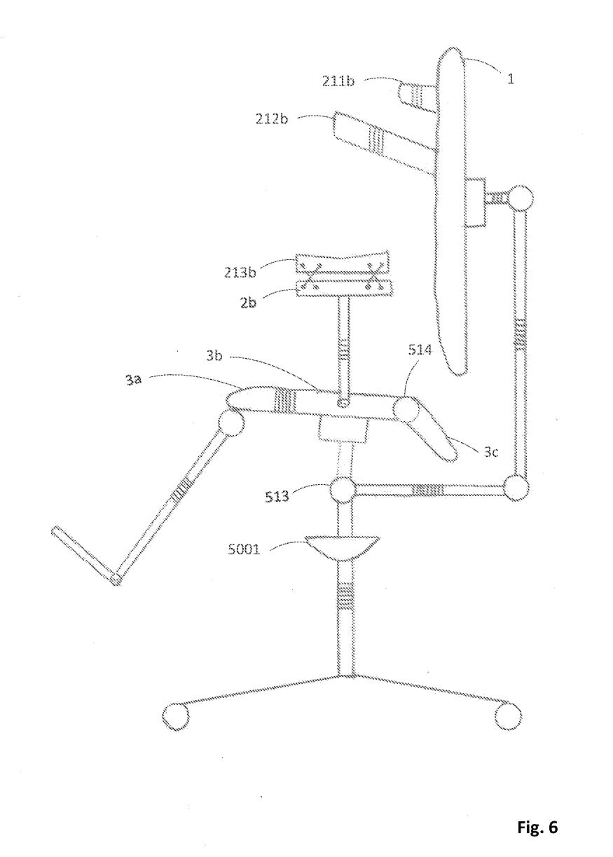

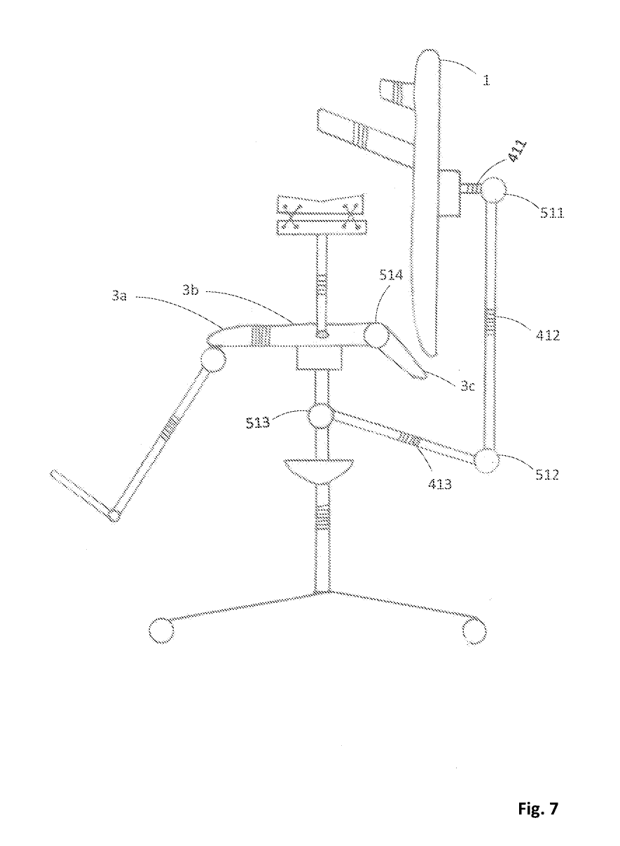

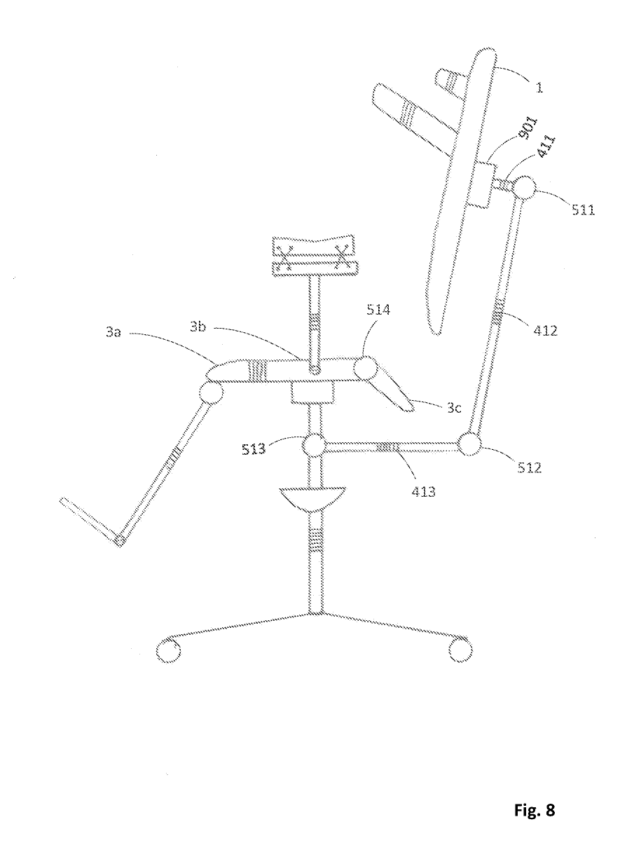

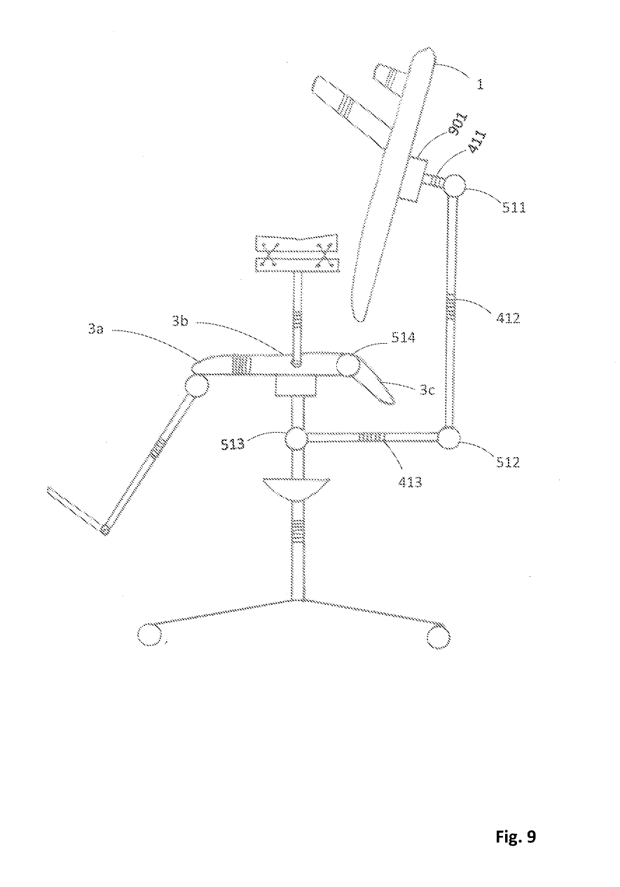

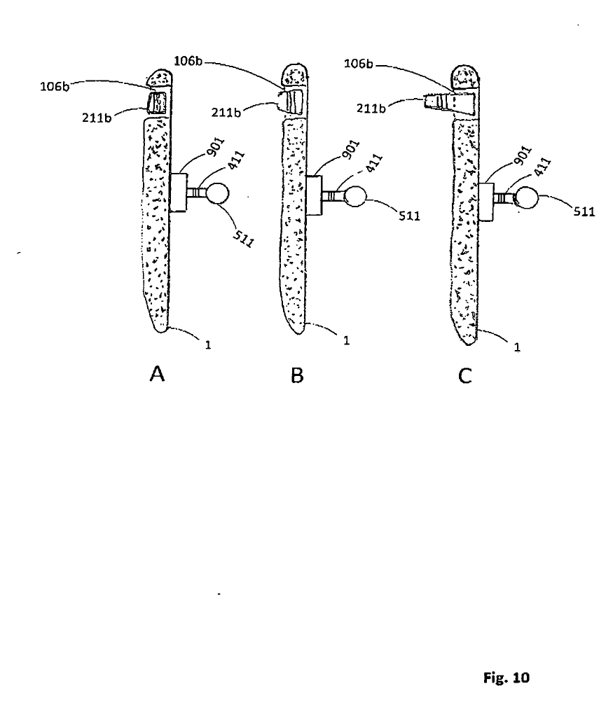

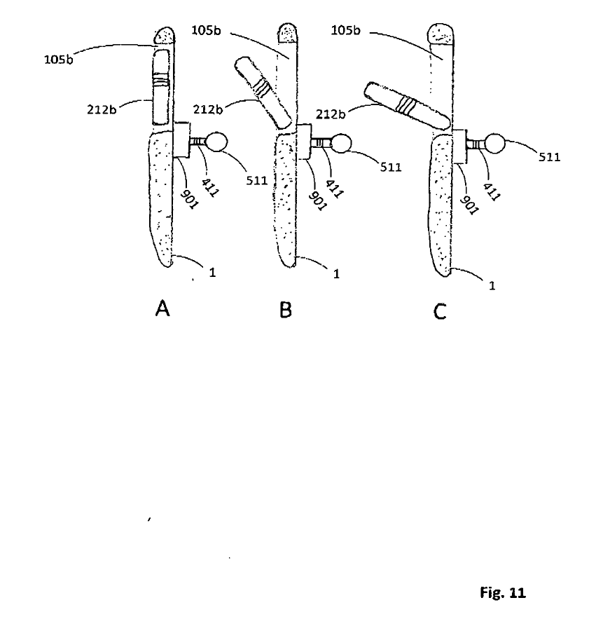

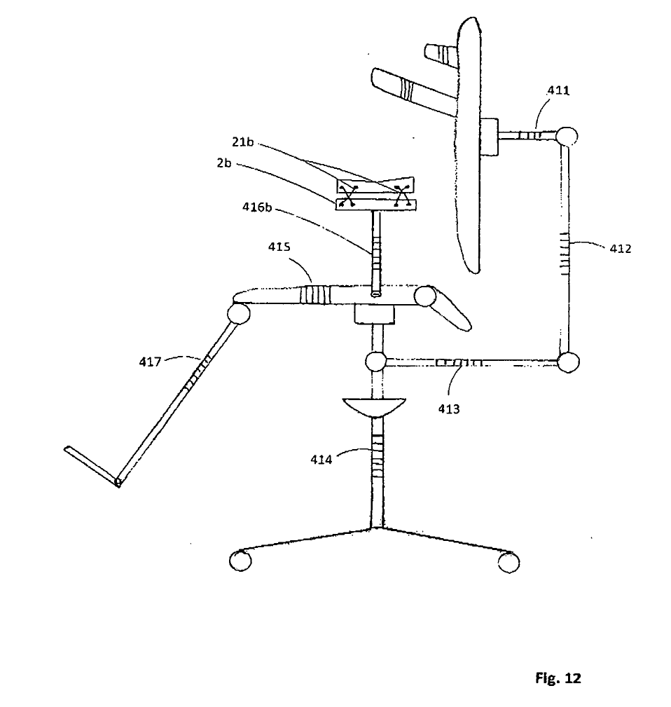

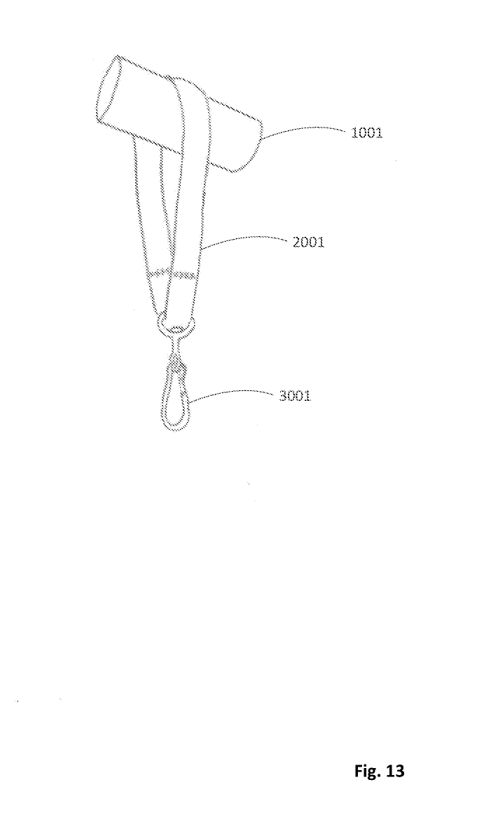

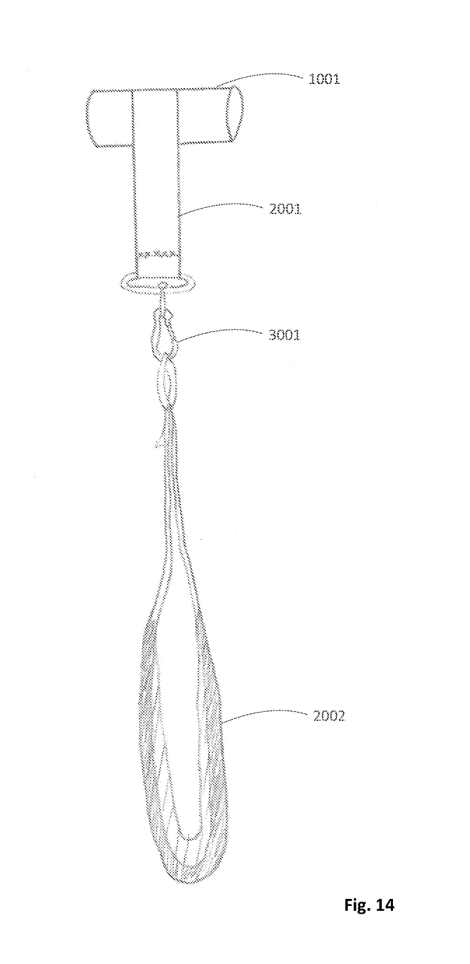

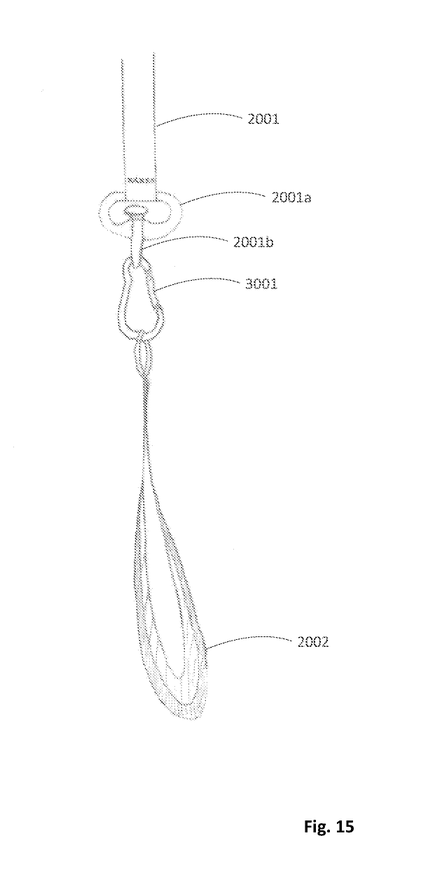

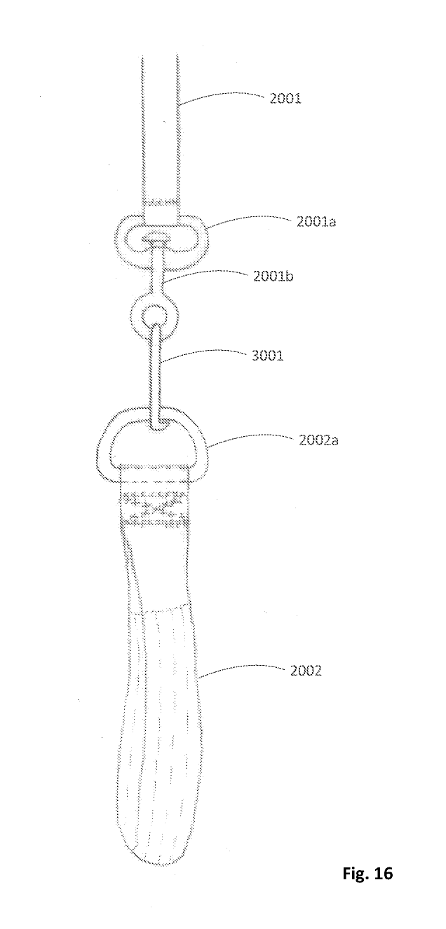

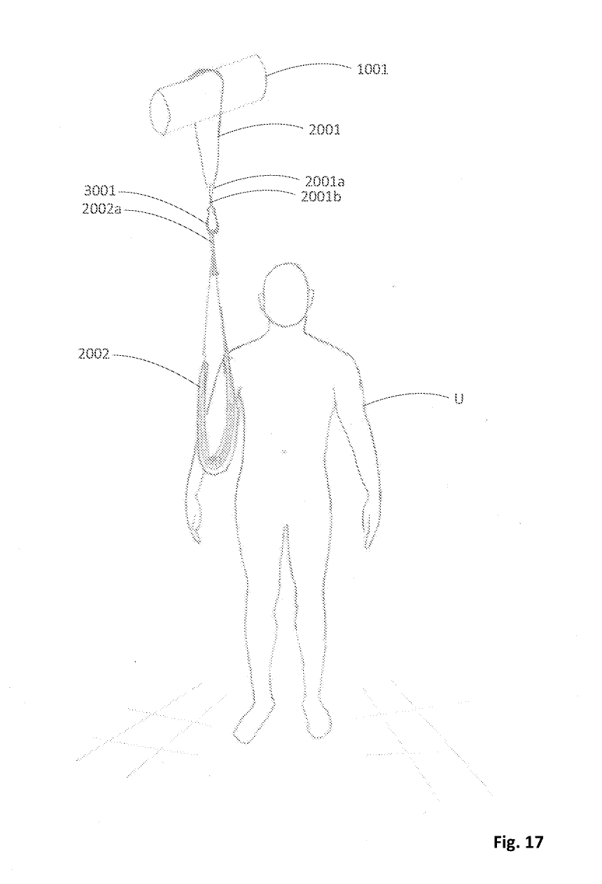

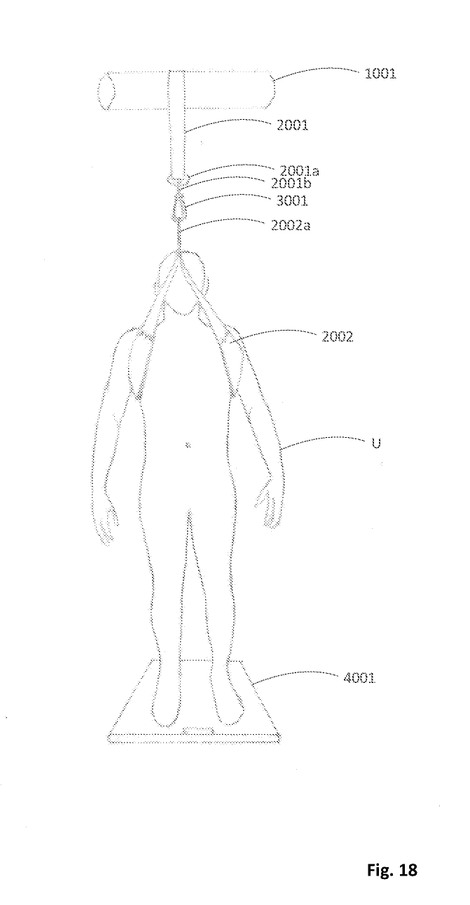

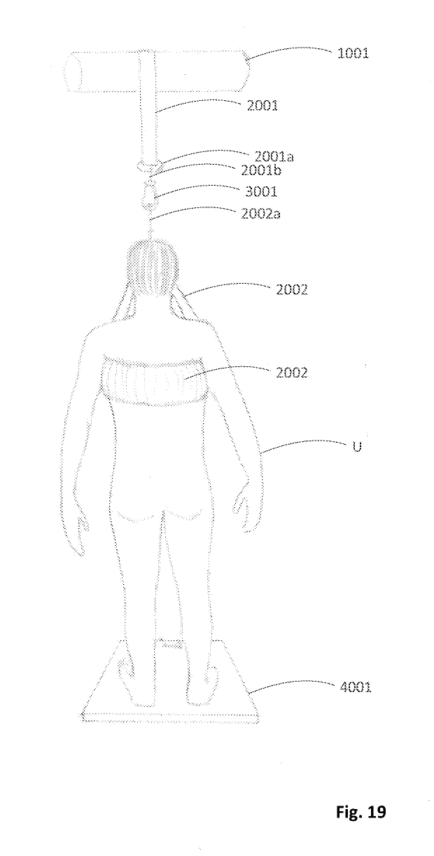

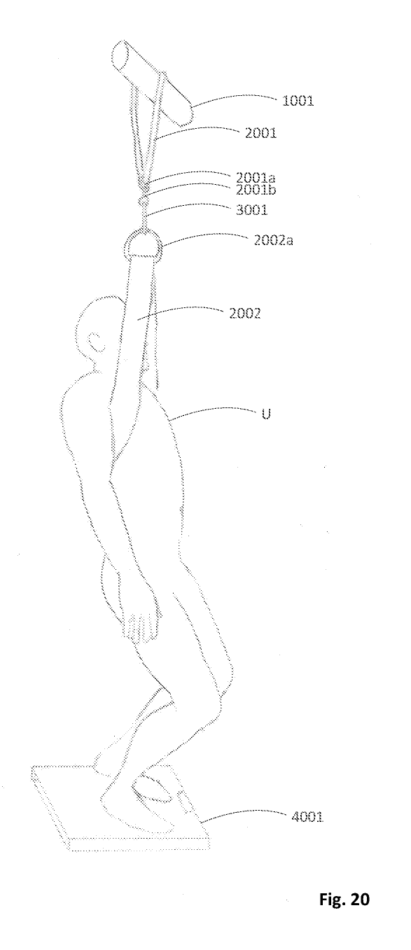

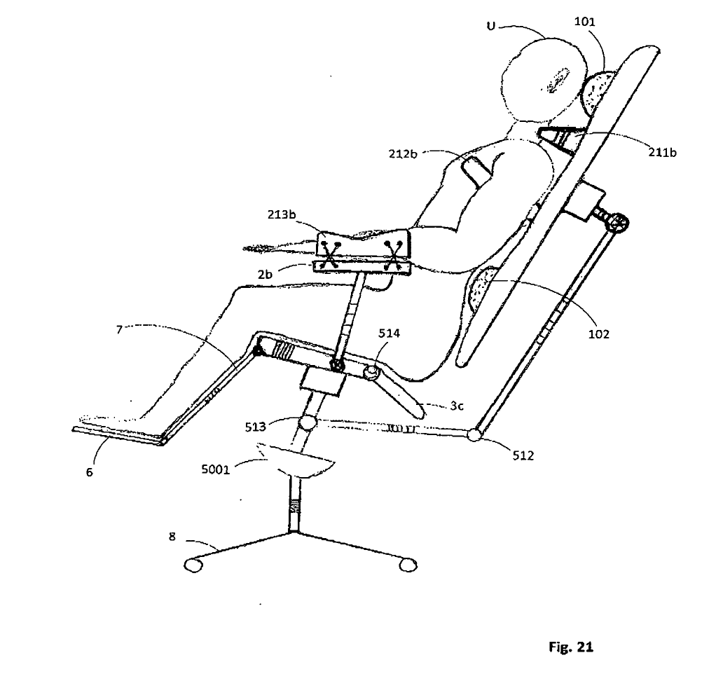

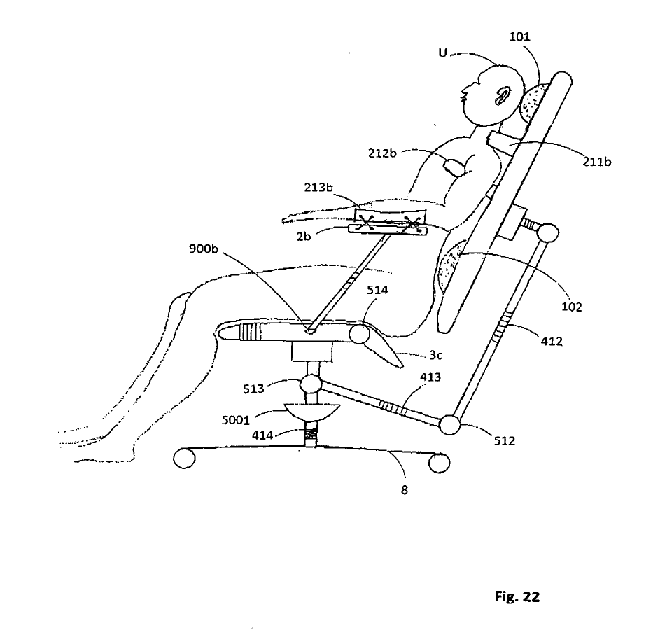

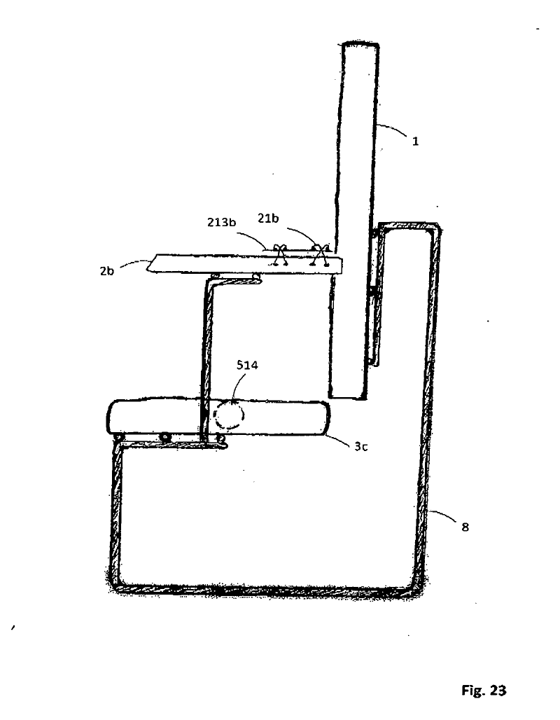

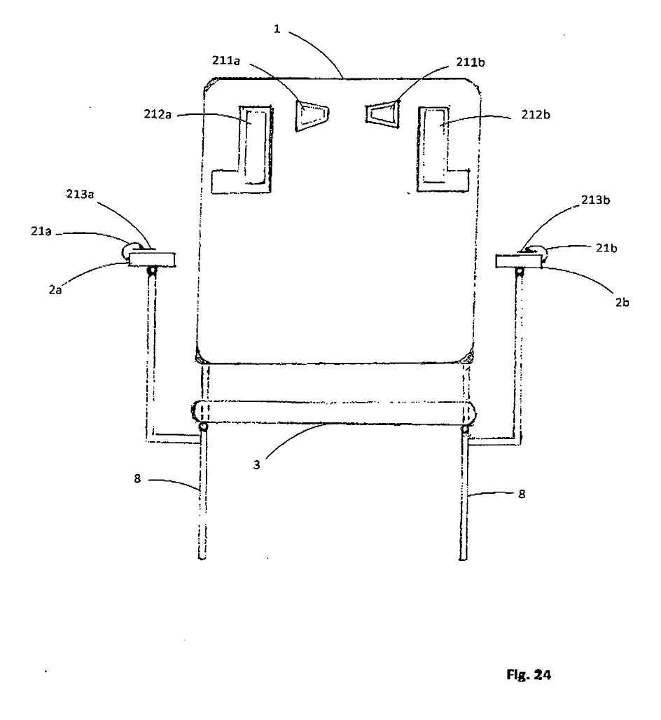

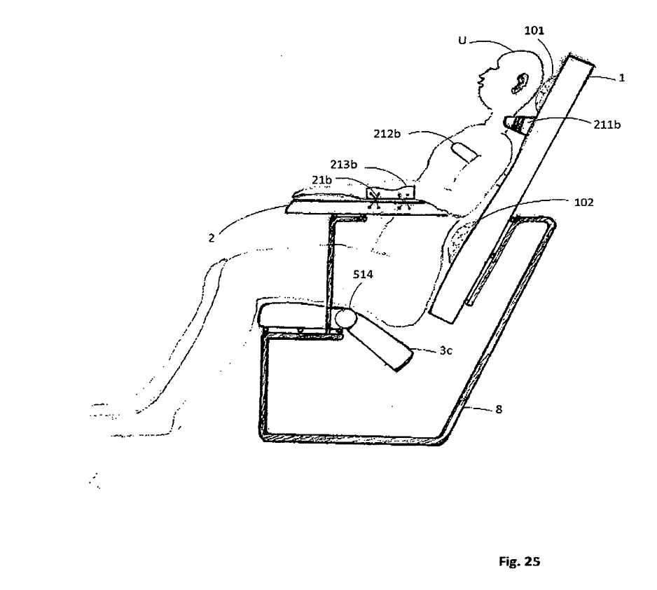

### DETAILED DESCRIPTION OF THE INVENTION

The theory of the method of decompressing the spine from the upright position by gravity is the core of the present invention. The method of decompressing the spine is to elevate the pressure, created by the body weight from standing or sitting position, to achieve maximum pain relieve by creating distance between the vertebral from the cervical C1 “Atlas” all the way down to the sacrum by the same amount of force which gives pressure to the spine. In accordance to this invention the upper body must be fixed from certain attachment points to let the gravity decompress the spine in a smooth gradual manner, not in a linear fashion, so the paraspinal muscles not to oppose changes in tension. For the brain to give the signal to the paraspinal muscles to fully relax, the body has to be in a secured relaxed position. This position will drive all not fixed parts under the fixation point down by gravity in a very natural relaxing way. The non-restriction in time will allow the spine to be decompressed for a longer period than known in other methods. The longer the time, the more the muscles gets relaxed and here the spine achieved the maximum decompression in a natural way from the upright position by gravity. That is the theory behind the two ways of upright decompression by either the seat or the standing decompressing system, in accordance with the present invention.

Decompression from the seated natural upright position:

The upper body must be fixed from certain points in the decompression seat, in accordance with the present invention. Two fold-in flaps 211a and 211b, buried inside the back of the seat, independently adjustable in width, length and height to fit all body shapes, opens outward to support and to fix the neck position and to hold the head for to decompress the disks in the cervical part of the spine. To attach the two ends together under the chin a belt will be used. The position of the flaps 211a and 211b can be adjusted independently, using the openings 106a and 106b.

Two fold-in arms 212a and 212b, buried inside the back of the seat, independently adjustable in width and length to fit all body shapes, opens downward to support and to fix the upper body and to carry the body weight. The position of the arms 212a and 212b can be adjusted independently, using the openings 105a and 105b.

In order to hold the arms down in place to get the maximum effect of spine decompression will need the handle flaps 213a and 213b connected to the seat handle by hinges 21a and 21b, included in the independently adjustable in height and in width arm rests 2a and 2b, to hold the elbows and forearms from moving away from the body outward and keep the arms close to the body. Now fixation of the upper body is complete.

Since this method of decompression is invented to fit individual body needs, the flexibility in the decompression seat is been executed through the extension parts 411, 412, 413, 414, 415, 416a and 416b, 417, 418a and 418b. All extension parts could be adjusted manually or mechanically.

Extension part 411 will extend horizontally to move the back of the seat 1 forward and back.

Extension part 412 will extend vertically to move the whole back of the seat 1 up and down.

Extension part 413 will extend horizontally to increase and decrease the distance between joint 512 and joint 513.

Extension part 414 will extend vertically to move the base of the seat 3b up and down.

Extension part 415 will extend horizontally base seat part 3a from base seat part 3b.

Extension parts 416a and 416b will extend independently vertically to move the arm rests up and down.

Extension part 417 will extend vertically to move the base of the foot rest 6 up and down.

Extension parts 418a and 418b will extend independently to adjust the width of the pair of forearm rests 2a and 2b.

All the Joints of the seat 511, 512, 513, 514, 515, 516 and 5001 are movable, adjustable and flexible individually freely and all will be fixable in a locked position individually to fit all body shapes and body needs. All adjustments could be done manually as well as mechanically.

Joint 511 is sole responsible for to move the back of the seat 1 out of the vertical, placed right behind extension part 411 on the back of the seat 1

Joint 512 is connecting the two arms that are holding part 1 and part 3 and is responsible to open and close the angle between back of the seat 1 and the base of the seat 3.

Joint 513 is responsible to adjust the base of the seat 3 out of the horizontal and to move the back of the seat 1 vertically up and down, placed right under the seat 3.

Tilt-Joint 5001 is placed under joint 513 and is sole responsible to recline the unit of seat 3 and back 1.

Joint 514 is located between seat parts 3b and the gravity flap 3c and sole responsible to open gravity flap 3c to conclude the final positioning of the upper body and therefore give maximum release to the spine.

Joint 515 is placed under 3a attached with cave support 7 and responsible to raise the lower leg and caves from under the caves part up to achieve maximum relaxation to the body.

Joint 516 is placed between foot rest 6 and cave support 7 and responsible for the adjustment of the feet position to achieve maximum relaxation to the body.

Seat 3 is divided in three parts 3a, 3b and gravity flap 3c. Part 3b is the steady support part and connected to the seat leg system. Part 3a is the end lip of the seat and extends horizontally by the adjustable extension 415 to fit the length of the femur. Taking in consideration, the base of the seat 3 will never interfere with the back of the seat 1.

Foot rest 6 is a freely movable flap, placed under cave support 7 by joint 516 to support the feet.

Cave support 7 is placed between seat 3 and foot rest 6 by joint 515 and joint 516 and extendable by extension 417 to fit the length of the lower leg. The main function is to support the lower legs, from the knees down.

Back of the seat 1 includes the parts: adjustable head rest 101, adjustable lumbar cushion 102, temperature strip 103, neck support 104, a pair of buried adjustable armpit supports 212a and 212b, two openings 105a and 105b to adjust the width to the armpit supports 212a and 212b, a pair of buried adjustable cervical supporting flaps 211a and 211b, two openings 106a and 106b to adjust independently the width to the supports 211a and 211b. Taking in consideration, the back of the seat 1 will never interfere with the base of the seat 3.

Pair of forearm rest 2a and 2b could be adjusted up and down by extension parts 416a and 416b and could be adjusted in width by extension part 418a and 418b.

Seat-leg-support-system 8 is located between seat 3 and the floor to hold the decompression seat in a comfortable adjustable height, on wheels or without.

900a and 900b are small joints to adjust the arm of the forearm rest 2a and 2b placed in the bottom end of adjuster armrest.

901 contact support box between the back of the seat 1 and the rest of the seat through the arm, holding the extension 411 connected to the joint 511.

902 contact support box between the seat base 3 and the leg support system through the arm, holding the extension 414 connected to the joint 513.

How the method works from the seated position:

The longer the time, the more the muscles gets relaxed and here we have a natural way of muscle relaxation. That created the way of upright decompression by the seat, in accordance with the present invention.

It's very simple to use. The user takes a seat like in any other normal chair. The two neck flaps will be placed beneath the ears, resting the head on the head support. The neck will be supported by the neck support. The back will be attached, rested and fully supported by the adjustable back of the seat. The lower back will be supported by the lumbar support. Placing the armpits on the two arm rests, resting the forearms on the two armrest after unfolding the two forearm flaps to hold the arms from moving away from the body, not contracting any upper body muscles at all. Of course, after adjusting the height and the width and all the other movable parts in the seat to fit the body shape, making sure the legs and the feet are in a very comfortable position and height, which is already provided from all the named joints and extension parts in the decompression seat. After releasing the gravity flap from the available joints according to the current desired level of decompression the brain will signal the muscles around the spine to relax and ease the tension because the body is in a very secured safe position. Here the spine will start decompressing itself naturally. The no-limits in time will be used as an advantage to help increase the amount of decompression in accordance to the theory of this method in the present invention. Here we achieved to decompress the spine from the upright seated position only by gravity. Coming out of DeCOMPRESSit Seat does not require special difficult long preparation, it will be as easy as coming out of a normal chair.

That is what makes the DeCOMPRESSit Seat the only natural and safe way for spinal decompression to fit all body types, ages and special conditions. It could facilitate obesity in upright position.

Decompression from the natural upright standing position:

The upper body must be fixed from certain points in the decompression harness belt, in accordance with the present invention.

A device to achieve this decompression method from the natural upright standing position: The device has harness belt, cable clipper, twisting anchor and adjustable Velcro belt and a scale.

The harness belt 2002 with length of 63 inch×1 inch thick×4 inch wide, with built in 2002a half inch thick cast-iron half-moon shaped ring with width of 3½ inch×2½ inch height, buried at the end of the non-padded section of the belt in 3 inch wide×4 inch long section sewed together around the ring for maximum durability, stability and safety. The flat part of the ring services as a comfortable pulling handle. The non-padded section of the harness belt 2002 is 13 inch long×3 inch wide from each end from 2002a half-moon-ring leaving 37 inch long×1 inch thick×4 inch wide of padded section covering around the 3 inch belt to achieve maximum comfort and security. Different size belts are made to fit individual needs.

Cable clipper 3001 services as connection between harness belt 2002 and the twisting anchor 2001b for smooth maneuvering for the user U.

Adjustable Velcro open belt 2001 with Velcro tap of 35 inch long×2 inch wide, with built in 2001a half inch thick cast-iron half-moon shaped ring with width of 2 inch×1 inch height, buried in the middle of the belt and connected to 2001b built in 2.3 inch-long anchor freely twisting through a permanent hole in 2001a. This belt is designed to hold up to 300 pounds' weight. Different size belts are made to fit individual needs.

Main holding bar 1001 with at least 4-inch-thick sturdy, firm and horizontal. Different sizes are made to fit individual needs.

Scale 4001 preferably a scale with a sound option to eliminate any unnecessary movements, placed on the floor directly under the user U.

The measurements mentioned here in this device are made to fit an individual with height of 6 feet tall, weight of 150 pounds and with chest diameter of about 45 inch. Proper size device should be used always and adjusted to align properly with the users' center of gravity to achieve maximum support for the individual and to place the user in a very relaxed position for maximum results, some results are instant some are for short-term and some are for long-term.

Here is some of the expected results

Instant pain relief

Help to align the spine

Allows the spine to manipulate itself and to stretch

Help the disc to snap back to its place

Increase the distance between the spinal vertebra

Increase the immune function system

Increase energy

The body could be moved without coming back to the normal spine compression level

Increase the essential nurturance and other substances into the disc

Improve the nerve function

Help to heal herniated disc

Help to heal sciatica nerve

Strengthen the paraspinal muscles

Strengthen the core muscles

Enhance the range of motion

Significant boosts in metabolism

Could be used for longer period of time

Help increase mobility

Increase level of hormones who are responsible of absorbing nurturance necessary for weight loss

Increase level of hormones who are responsible of releasing hazardous toxins

Safe to use

The advantage of the standing DeCOMPRESSit device are,

Easy to set up

Easy to carry around

Fit in a small gym bag

User friendly

Fits all body shapes

Suitable to any age

Suitable to any individual condition

Could be used in any place

Multi-function

Gravity is the main force

Adjustable

Availability in different sizes

No assistant needed

No weights are needed

No special tools are needed

No change of outfit needed

Help avoid the surgical option

Available to connect more accessories

Easy to get out of

Easy to maneuver within

The body could be moved without coming back to the normal spine compression level

No compression to the blood veins traveling under the harness belt

It could be operated by an app for exercises

It could be operated by virtual reality goggles

Affordable

Safe to use

How does it work?

Standing is the main idea for this decompression method, the user will be in total control of the level of decompressing the spine without weights only by gravity.

The harness belt 2002 should end approximately where the users' U pelvic girdle bone starts. The user U will be standing directly behind the harness belt 2002, the half-moon-ring 2002a should be placed in the front of the users' U forehead when the arms are pointed down towards the floor in a normal upright standing position, then the user will get in the harness belt with arms then head then shoulders till the belt rests on the lower part of the back blades and the harness belt 2002 comes from behind and under the armpits, going upwards resting on the ribcage without pressuring on the blood veins, keeping the feet on the scale 4001, by flexing the knees slightly to let the belt take over the bodyweight and that should be heard and seen on the decrease of the weight on the scale, at this point the decrease of the pressure on the spine and the discs will allow the gravity to start decompressing the spine for instant pain relief, quick adjust to the spine and help to snap the bulging disc back in its place in a safe manner only by gravity. The process of decompressing the spine needs gradual increase in the level of the decompression, the more the scale keep showing gradual decrease in the weight per the current desired level of decompression the brain will signal the muscles around the spine to relax and ease the tension because the body is in a very secured and safe position so the spine will keep decompressing itself naturally. The no-limits in time will be used as an advantage to help increase the amount of decompression. Coming out of DeCOMPRESSit standing device is easy and does not require any difficult preparations, just by extending the knees back up gradually to increase the weight on the scale once again. Here we achieved to decompress the spine from the upright standing position only by gravity in accordance to the theory of this method in the present invention.

That is what makes the DeCOMPRESSit the only natural and safe way for spinal decompression from the standing upright position by gravity.

That is the theory behind the standing upright decompression device, in accordance with the present invention.

I claim:

1. The theory of the method of decompressing the human spine by gravity from the upright position, comprising the fixation of the upper human body in the natural upright position and freeing the not fixed parts by driving all not fixed parts under the fixation point down by gravity.

2. A method of decompressing the human spine from the seated position, comprising 1 in sitting position.

3. A method of decompressing the human spine from the standing position, comprising 1 in standing position.

4. The decompression seat according claim 2, comprising:
A. Two fold-in arms, buried inside the back of the seat, independently adjustable in width and length, opens downward to support and to fix the upper body and to carry the body weight. The position of the arms can be adjusted independently, using two openings.
B. Two openings in the back of the seat as the main opening to adjust in width according claim 4a.
C. Two fold-in neck flaps, buried inside the back of the seat, independently adjustable in width, length and height, opens outward. The position of the flaps can be adjusted independently, using two openings.
D. Two openings in the back of the seat as the main opening to adjust in width according claim 4c.
E. A belt to attach the two ends of the flaps in claim 4c together under the chin.
F. The gravity flap, located in the base of the seat, opens downwards to conclude the final decompressing position of the upper body as claimed in 2
G. Joints, adjustable and flexible individually freely and all are fixable in a locked position individually to reach the final decompression position of the upper body as claimed in 2.
H. A cave support, adjustable in length and angle to reach the final decompressing position of the upper body as claimed in 2.
I. A foot rest, foldable and adjustable in angle to reach the final decompression position of the upper body as claimed in 2.
J. Extensions, extendable individually in accordance with its position in the seat as claimed in 4.
K. A Tilt-Joint, placed under the base system of the seat in claim 5, to recline the whole seat to reach the final decompression position of the upper body as claimed in 2.
L. A pair of handle flaps, individually foldable opens to the vertical position to hold the forearms, placed on a pair of adjustable in height and width arm rest, to reach the final decompression position of the upper body as claimed in 2.
M. A neck support, removable and adjustable in depth, located between fold-in neck flaps in claim 4c
N. A head rest, adjustable in depth, placed above the neck support in claim 4m
O. A lumbar cushion, adjustable in depth, placed in the lower back of the seat as claimed in 4
P. A temperature strip, adjustable in temperature, embodied in the center of the back of the seat as claimed in 4, aligned to the spine
Q. All extension parts in claim 4 are adjustable either manually or mechanically

5. The decompression device according claim 3, comprising:
A. A unit of a padded ribcage harness brace, a half-moon shaped ring and an anchor comprising:
I. A padded ribcage harness brace fixing the upper end of the ribcage resting on the lower end of the back blades and embracing the ribcage coming from under the armpits, continuing upwards to meet in the front of the users' forehead, while the user is standing on the floor.
II. A half-moon shaped ring of minimum 3.5 inch diameter and 0.5 inch thick to hold the ends of the ribcage harness brace according claim 5a I. together and to serve as a handle for the user and equipped with a permanent cavity hosting a freely twisting anchor with a connector.
B. The position of the anchor in claim 5a II. must be aligned as close as possible with the center of gravity of the human body.
C. The final decompression position of the human body in accordance with claim 3 must be: body is in a very relaxed stable and safe position, the anchor according claim 5a II. placed over the head must be aligned with the center of gravity of the body, arms pointing down, knees are flexed, feet are on the floor.
